(19) United States
(12) Patent Application Publication
(10) Pub. No.: US 2025/0131466 A1
(43) Pub. Date: Apr. 24, 2025

(54) VEHICLE CONTROL DEVICE, INFORMATION COLLECTION SYSTEM INCLUDING THE SAME, AND INFORMATION COLLECTION METHOD

(71) Applicants: Hyundai Motor Company, Seoul (KR); Kia Corporation, Seoul (KR); Sogang University Research & Business Development Foundation, Seoul (KR)

(72) Inventors: Jae Hyuk Choi, Hwaseong (KR); Soo Yong Park, Seoul (KR); Si Woo Seong, Seoul (KR); Jung Won Seo, Seoul (KR)

(21) Appl. No.: 18/917,147

(22) Filed: Oct. 16, 2024

(30) Foreign Application Priority Data
Oct. 19, 2023 (KR) 10-2023-0140555

(51) Int. Cl. G06Q 30/0226; G01W 1/00; G01W 1/12

(52) U.S. Cl. CPC G06Q 30/0231; G01W 1/12; G01W 2001/006

(57) ABSTRACT

A vehicle control device includes a memory that stores program instructions and a processor that executes the program instructions. The processor may obtain at least one of sunlight amount information, temperature information, location information, or time information, and in response, may provide a reward to a user of the vehicle control device in the form of mileage in response to the user transmitting at least one of the obtained sunlight amount information, the obtained temperature information, the obtained location information, or the obtained time information to a server. The mileage may be used as payment for a good, information, or a service, which is identified based on an input of the user of the vehicle control device.

### CROSS-REFERENCE TO RELATED APPLICATION

This application claims under 35 U.S.C. § 119(a) the benefit of Korean Patent Application No. 10-2023-0140555, filed in the Korean Intellectual Property Office on Oct. 19, 2023, the entire contents of which are incorporated herein by reference.

### BACKGROUND

### (a) Technical Field

The present disclosure relates to a vehicle control device, an information collection system, and an information collection method, more particularly, to the vehicle control device for collecting certain information, in which a user is provided with mileage as a reward for providing the information.

### (b) Description of the Related Art

In recent years, the need for development and dissemination of renewable energy has increased as the problems of climate change and environmental pollution have intensified. Solar energy generation has been attracting attention as a renewable energy source for reducing climate change because it has low carbon emissions and does not consume fossil fuels.

As the use of solar cells, which convert light energy into electrical energy, becomes more common, drivers may generate solar energy by installing solar cells on the roof panels of their vehicles. The solar energy generated may be stored in a battery and used to operate the vehicle. By introducing solar power generation, which collects sunlight to generate electrical energy, in vehicles, it has become possible to reduce greenhouse gas emissions.

The technical problems of the present disclosure are not limited to the aforementioned problems, and any other technical problems not mentioned herein will be clearly understood from the following description by those skilled in the art.

### SUMMARY

An aspect of the present disclosure provides a vehicle control device for encouraging the production of solar energy by allowing a user of a vehicle control device to receive mileage based on transmitting generated weather-related information.

An aspect of the present disclosure provides an information collection system including a vehicle control device and a server, which encourages the production of solar energy by assigning and/or deducting mileage to a user of the vehicle control device and/or an external server based on collecting generated weather-related information.

An aspect of the present disclosure provides an information collection method which encourages the production of solar energy by assigning and/or deducting mileage to a user of a vehicle control device and/or an external server based on collecting generated weather-related information.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control device may include a memory that stores program instructions and a processor that executes the program instructions.

According to an embodiment, the processor may obtain at least one of sunlight amount information indicating an amount of sunlight shining on a vehicle including the vehicle control device, temperature information indicating an external temperature of the vehicle, location information indicating a location of the vehicle, or time information, or any combination thereof, and allow a user of the vehicle control device to obtain mileage by transmitting at least one of the obtained sunlight amount information, the obtained temperature information, the obtained location information, or the obtained time information, or any combination thereof to a server. The mileage may be provided to the user of the vehicle control device as a reward for transmitting at least one of the obtained sunlight amount information, the obtained temperature information, the obtained location information, or the obtained time information, or any combination thereof to the server. The time information may indicate a time at which at least one of the obtained sunlight amount information, the obtained temperature information, or the obtained location information, or any combination thereof is obtained.

According to an embodiment, the vehicle control device may further include a roof panel equipped with a solar cell that generates electricity by the sunlight and configured to generate the sunlight amount information. A light-receiving surface of the solar cell included in the roof panel may be disposed toward outside of the vehicle.

According to an embodiment, the mileage may be used as payment for a good, information, or a service.

According to an embodiment, the mileage may be generated using blockchain technology and assigned to a user from the server.

According to an embodiment, the processor may provide a user interface (UI) or a user experience (UX) for guiding the user to sell at least one of the obtained sunlight amount information, the obtained temperature information, the obtained location information, or the obtained time information, or any combination thereof to the server.

According to an embodiment, the processor may provide a user interface (UI) or a user experience (UX) for guiding the user to request assignment of mileage corresponding to at least one of sunlight amount information for which the mileage is not assigned, temperature information for which the mileage is not assigned, location information for which the mileage is not assigned, or time information for which the mileage is not assigned, or any combination thereof, after transmitting at least one of the obtained sunlight amount information, the obtained temperature information, the obtained location information, or the obtained time information, or any combination thereof to the server.

According to an embodiment, at least one of the sunlight amount information, the temperature information, the location information, or the time information, or any combination thereof may be used to identify processed information that represents weather-related information.

A vehicle may include the vehicle control device.

According to an aspect of the present disclosure, an information collection system may include a vehicle control device, and a server.

According to an embodiment, the processor may obtain at least one of sunlight amount information indicating an amount of sunlight shining on a vehicle including a vehicle control device, temperature information indicating an external temperature of the vehicle, location information indicating a location of the vehicle, or time information, or any combination thereof; and allow a user of the vehicle control device to obtain mileage by transmitting at least one of the obtained sunlight amount information, the obtained temperature information, the obtained location information, or the obtained time information, or any combination thereof to a server. The server may receive at least one of the obtained sunlight amount information, the obtained temperature information, the obtained location information, or the obtained time information, or any combination thereof from the vehicle control device, and assign mileage to the user of the vehicle control device as reward for receiving at least one of the obtained sunlight amount information, the obtained temperature information, the obtained location information, or the obtained time information, or any combination thereof. According to an embodiment, the mileage may be managed by the server, and used for payment of a good, information, or a service, which is identified based on an input of a user of the vehicle control device. The time information may indicate a time at which at least one of the obtained sunlight amount information, the obtained temperature information, or the obtained location information, or any combination thereof is obtained.

According to an embodiment, the server may deduct mileage corresponding to a price of the good from mileage before payment for the good is made, to perform the payment for the good.

According to an embodiment, the server may update information included in mileage obtained by the user of the vehicle control device and information included in mileage obtained by a user of the vehicle control device different from the user of the vehicle control device with details of the assigned or deducted mileage.

According to an embodiment, the server may identify an input of a user of an external server for specifying at least one of the sunlight amount information, the temperature information, the location information, or the time information, or any combination thereof, and transmit at least one of the specified sunlight amount information, the specified temperature information, the specified location information, or the specified time information, or any combination thereof to the external server, in response to receiving reward for at least one of the specified sunlight amount information, the specified temperature information, the specified location information, or the specified time information, or any combination thereof.

According to an embodiment, the server may perform a payment for purchasing at least one of the specified sunlight amount information, the specified temperature information, the specified location information, or the specified time information, or any combination thereof from the server through mileage of the external server.

According to an embodiment, the server may deduct the mileage of the external server before the payment is performed by a mileage corresponding to the price of at least one of the specified sunlight amount information, the specified temperature information, the specified location information, or the specified time information, or any combination thereof to perform the payment.

According to an embodiment, the server may provide the vehicle control device or a terminal of the user with a user interface (UI) or a user experience (UX) for guiding the user to sell at least one of the obtained sunlight amount information, the obtained temperature information, the obtained location information, or the obtained time information, or any combination thereof to the server, and provide the external server or a terminal of the user of the external server with a user interface (UI) or a user experience (UX) for guiding the user of the external server to purchase at least one of the sunlight amount information, the temperature information, the location information, or the time information, or any combination thereof from the server.

According to an embodiment, the server may provide the vehicle control device or a terminal of a user with a user interface (UI) or a user experience (UX) for guiding the user to request assignment of mileage corresponding to at least one of sunlight amount information for which the mileage is not assigned, temperature information for which the mileage is not assigned, location information for which the mileage is not assigned, or time information for which the mileage is not assigned, or any combination thereof, after receiving at least one of the obtained sunlight amount information, the obtained temperature information, the obtained location information, or the obtained time information, or any combination thereof from the vehicle control device.

According to an embodiment, the server may identify processed information representing weather-related information based on at least one of the obtained sunlight amount information, the obtained temperature information, the obtained location information, or the obtained time information, or any combination thereof, and transmit the processed information to the external server in response to receiving reward for the processed information from the external server.

According to an aspect of the present disclosure, an information collection method includes obtaining, by a vehicle control device, at least one of sunlight amount information indicating an amount of sunlight shining on a vehicle including the vehicle control device, temperature information indicating an external temperature of the vehicle, location information indicating a location of the vehicle, or time information, or any combination thereof, transmitting, by the vehicle control device, at least one of the obtained sunlight amount information, the obtained temperature information, the obtained location information, or the obtained time information, or any combination thereof to a server, receiving, by the server, at least one of the obtained sunlight amount information, the obtained temperature information, the obtained location information, or the obtained time information, or any combination thereof from the vehicle control device, and assigning, by the server, to a user of the vehicle control device, mileage as reward for receiving at least one of the obtained sunlight amount information, the obtained temperature information, the obtained location information, or the obtained time information, or any combination thereof. The mileage may be managed by the server, and used for payment of good, information, or service, which is identified based on an input of the user of the vehicle control device. The time information may indicate a time at which at least one of the obtained sunlight amount information, the obtained temperature information, or the obtained location information, or any combination thereof is obtained.

According to an embodiment, the information collection method may further include deducting, by the server, mileage corresponding to a price of the good from mileage before payment for the good is performed to perform payment for the good identified based on an input of the user of the vehicle control device.

According to an embodiment, the information collection method may further include updating, by the server, information included in mileage obtained by the user of the vehicle control device and information included in mileage obtained by a user of the vehicle control device different from the user of the vehicle control device with details of the assigned or deducted mileage.

According to an embodiment, the information collection method may further include identifying, by the server, an input of a user of an external server for specifying at least one of the sunlight amount information, the temperature information, the location information, or the time information, or any combination thereof, and transmitting, by the server, at least one of the specified sunlight amount information, the specified temperature information, the specified location information, or the specified time information, or any combination thereof to the external server, in response to receiving reward for at least one of the specified sunlight amount information, the specified temperature information, the specified location information, or the specified time information, or any combination thereof.

According to an embodiment, the transmitting, by the server, at least one of the specified sunlight amount information, the specified temperature information, the specified location information, or the specified time information, or any combination thereof to the external server, in response to receiving reward for at least one of the specified sunlight amount information, the specified temperature information, the specified location information, or the specified time information, or any combination thereof may include performing payment for purchasing at least one of the specified sunlight amount information, the specified temperature information, the specified location information, or the specified time information, or any combination thereof, through mileage of the external server.

According to an embodiment, the performing payment for purchasing at least one of the specified sunlight amount information, the specified temperature information, the specified location information, or the specified time information, or any combination thereof, through mileage of the external server may include deducting, by the server, mileage corresponding to a price of at least one of the specified sunlight amount information, the specified temperature information, the specified location information, or the specified time information, or any combination thereof from mileage of the external server before the payment is performed.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of mileage acquired and/or deducted according to the collection of weather-related information in an information collection system or information collection method including a vehicle control device according to an embodiment of the present disclosure;

FIG. 2A is a block diagram of a vehicle control device according to an embodiment of the present disclosure;

FIG. 2B is a diagram specifically showing a vehicle control device according to an embodiment of the present disclosure;

FIG. 2C is a block diagram of an information collection system according to an embodiment of the present disclosure;

FIG. 2D is a diagram specifically illustrating an information collection system according to an embodiment of the present disclosure;

FIG. 3A shows an example of a screen displayed for information collection in an information collection system or information collection method according to an embodiment of the present disclosure;

FIG. 3B shows an example of a screen displayed for obtain an input of a user of a vehicle control device for providing weather-related information to a server in an information collection system or information collection method according to an embodiment of the present disclosure;

FIG. 4A shows an example of a screen displayed to obtain an input of a user in an information collection system or information collection method according to an embodiment of the present disclosure;

FIG. 4B shows an example of a screen displayed to obtain an input of a user of the vehicle control device specifying a good to purchase in an information collection system or information collection method according to an embodiment of the present disclosure;

FIG. 5 shows an example of a screen displayed for information sale in an information collection system or information collection method according to an embodiment of the present disclosure;

FIG. 6A shows a flowchart of operations of a vehicle control device and a server, for information collection in an information collection system or information collection method according to an embodiment of the present disclosure;

FIG. 6B shows an example of signaling between a vehicle control device, a server, an external server, and a market for information collection in an information collection system or information collection method according to an embodiment of the present disclosure; and

FIG. 7 shows a computing system related to an information collection system or information collection method according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

By guaranteeing the integrity of user-generated data, it is possible for users to be able to manage and control their own data. In the vehicle field, drivers are able to produce and trade data. Through the present disclosure, drivers may not only produce renewable energy through solar panels, but also trade data produced through solar panels through an exchange medium. Data trading may increase the penetration of facilities for renewable energy production and enhance the driver experience.

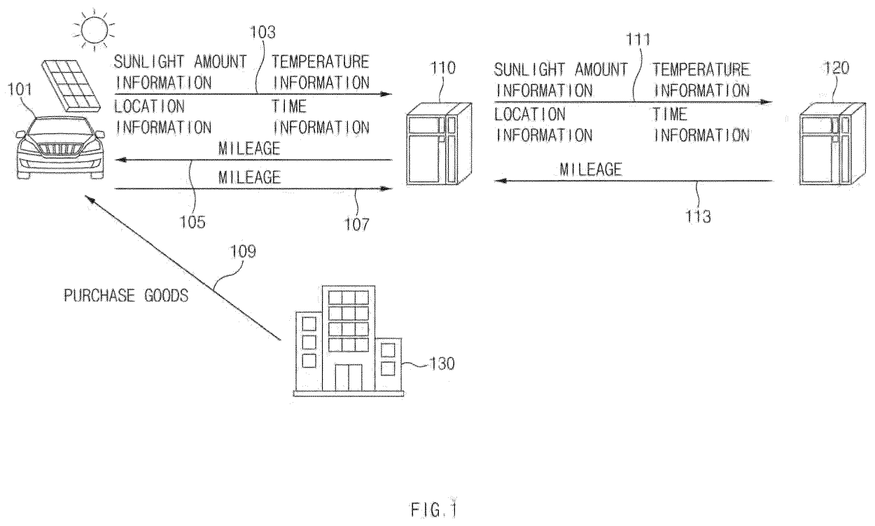

Hereinafter, embodiments of the present disclosure will be described in detail with reference to FIGS. 1 to 7.

FIG. 1 shows an example of mileage acquired and/or deducted according to the collection of weather-related information in an information collection system or information collection method including a vehicle control device according to an embodiment of the present disclosure.

Referring to FIG. 1, a vehicle control device 101 according to an embodiment of the present disclosure may be implemented inside or outside a vehicle, and some of components included in the vehicle control device 101 may be implemented inside or outside the vehicle.

Referring to FIG. 1, an information collection system according to an embodiment of the present disclosure may include the vehicle control device 101 and a server 110. The vehicle control device 101 may obtain weather-related information. An external server 120 may collect weather-related information along with the server 110. The user of the vehicle control device 101 may trade goods with a company 130 through mileage.

In operation 103, according to an embodiment, the vehicle control device 101 may transmit the obtained weather-related information to the server 110 for sale. The server 110 may receive the weather-related information from the vehicle control device 101. In other words, the vehicle control device 101 may sell the obtained weather-related information to the server 110.

To transmit weather-related information to the server 110, the vehicle control device 101 may obtain the weather-related information. The weather-related information may include at least one of sunlight amount information, temperature information, location information, or time information, or any combination thereof.

According to an embodiment, the sunlight amount information may be obtained through a roof panel and/or a solar cell of a vehicle including the vehicle control device 101. The sunlight amount information may refer to the amount of sunlight falling on the vehicle, the vehicle's roof panel, the vehicle's solar cells, and/or the ground surface. The sunlight amount information may be identified based on the amount of sunlight shining per unit area. According to an embodiment, the temperature information may refer to the temperature of the exterior of the vehicle. The temperature information may be obtained by a temperature measuring device. According to an embodiment, the location information may refer to the location of the vehicle including the vehicle control device. According to an embodiment, the time information may refer to the time at which one of sunlight amount information, temperature information, location information, or a combination thereof is obtained. For example, the sunlight amount information, the temperature information, and/or the location information may be obtained at specified time intervals.

In operation 105, according to an embodiment, the server 110 may assign mileage to a user of the vehicle control device 101 based on receiving weather-related information (e.g., at least one of the sunlight amount information, the temperature information, the location information, or the time information, or any combination thereof) from the vehicle control device 101.

The mileage may be assigned as reward for transmitting the obtained weather-related information to the server 110. For example, the greater the number of pieces of transmitted weather-related information, the more mileage the user of the vehicle control device 101 may obtain. For example, the larger the size of the transmitted weather-related information, the more mileage the user of the vehicle control device 101 may obtain.

The mileage may be managed by the server and may be used to perform payment for good, information, or service, that is identified based on an input from the user of the vehicle control device.

For example, the mileage may represent the amount of virtual currency. For example, the mileage may be referred to as, but is not limited to, virtual currency, coins, points, and/or tokens. According to an embodiment, the mileage may be generated using blockchain technology and assigned to the user from the server. For example, the server may update the information contained in the mileage obtained by the user of the vehicle control device and the information contained in the mileage obtained by the user of the vehicle control device, which is different from the user of the vehicle control device from which mileage is credited or deducted, with the mileage details credited or deducted from the user of the vehicle control device. The reliability of mileage generated through blockchain technology may be higher than the reliability of mileage not generated through blockchain technology. This is because data integrity is secured.

In operation 107, according to an embodiment, to perform payment for a good identified based on the input of the user of the vehicle control device 101, the server 110 may deduct the mileage before payment for the good is performed by the mileage corresponding to the price of the good.

According to an embodiment, the user of the vehicle control device 101 may generate an input to purchase a good. The good may include products provided by the server 110 (e.g., car care products, car accessories). The server 110 may identify the price of a good based on an input of the user of the vehicle control device 101. The server 110 may deduct the mileage corresponding to the price of the good from the mileage of the user of the vehicle control device 101 before payment is made.

In operation 109, according to an embodiment, the user of the vehicle control device 101 may receive a good purchased with the mileage of the user of the vehicle control device 101 from the company 130.

In operation 111, according to an embodiment, the external server 120 may receive weather-related information from the server 110 for purchase. The server 110 may transmit weather-related information to the external server 120 for sale. To transmit weather-related information, the server 110 may identify an input of a user of the external server 120 for specifying weather-related information.

According to another embodiment, the server 110 may identify processed information (e.g., ultraviolet ray information, cloud amount information, maximum temperature information, minimum temperature information, sunshine hours information) based on weather-related information (e.g., sunlight amount information, temperature information, location information, or time information) received from the vehicle control device 101. For example, the server 110 may identify that the larger the sunlight amount information, the smaller the cloud amount information. For example, the server 110 may identify maximum temperature information indicating the highest temperature during a specified time through time information and temperature information. For example, the server 110 may identify minimum temperature information indicating the lowest temperature during a specified time through time information and temperature information. The server 110 may transmit the processed information to the external server 120 in response to receiving reward for the processed information from the external server 120.

In operation 113, according to an embodiment, the server 110 may deduct a mileage of the external server 120 based on transmitting weather-related information. In other words, the external server 120 may purchase weather-related information generated by the vehicle control device 101 from the server 110 through mileage. According to another embodiment, the external server 120 may purchase processed information identified based on weather-related information generated by the vehicle control device 101 from the server 110 through mileage.

According to an embodiment, the external server 120 may be controlled by a business operator that processes and utilizes weather-related information. For example, the external server 120 may be controlled by a smart farm operator. The smart farm operator may adjust the growing environment (e.g., temperature or humidity) of crops based on obtained weather-related information. For example, the external server 120 may be controlled by a weather information consumer such as the Korea Meteorological Administration. The weather information consumer may sell, to general consumers, processed information (e.g., ultraviolet ray information, cloud amount information, maximum temperature information, minimum temperature information, and sunshine hours information) that is the result of processing the obtained weather-related information.

Although it is illustrated in FIG. 1 that goods are purchased only from the company 130 that controls the server 110, embodiments of the present disclosure may not be limited thereto. According to an embodiment, mileage (e.g., cryptocurrency) obtained as reward for selling weather-related information may serve as an exchange medium not only for the company 130 that controls the server 110, but also for other companies. When mileage serves as an exchange medium for other companies, mileage may be used like currency.

Although it is shown in FIG. 1 that the user of the external server 120 purchases weather-related information through mileage, embodiments of the present disclosure may not be limited thereto. The user of the external server 120 may purchase weather-related information through reward (e.g., payment) for the weather-related information. The server 110 may transmit weather-related information to the external server 120 in response to receiving reward for the weather-related information.

Although it is described in FIG. 1 that good, information, or service for which payment is made is identified based on the input of the user of the vehicle control device, embodiments of the present disclosure may not be limited thereto. According to an embodiment, good, information, or service for which payment is made may be identified based on the input of the user of the vehicle.

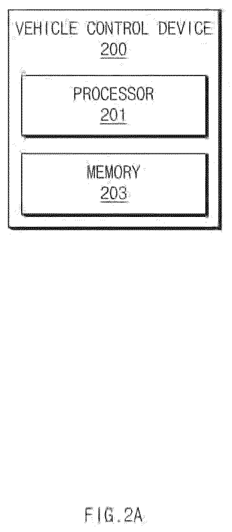

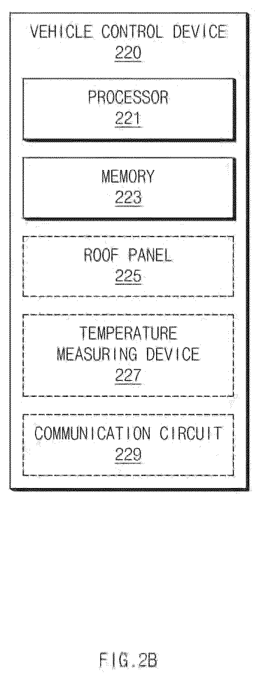

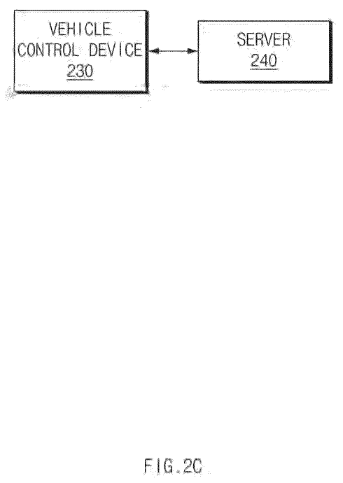

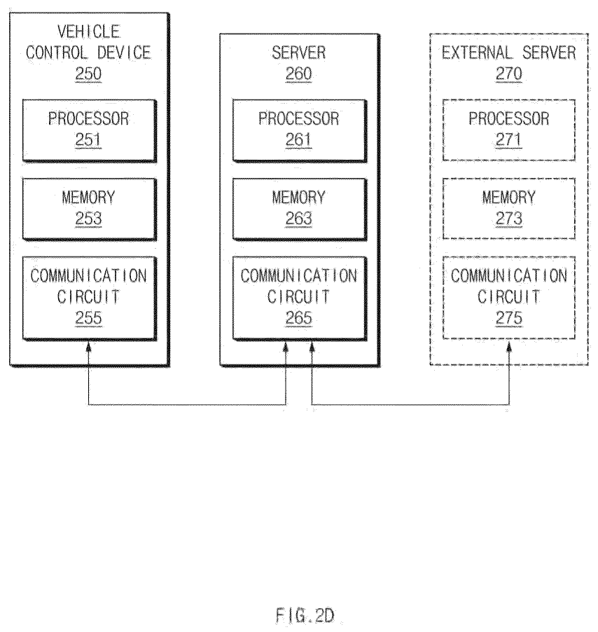

FIG. 2A is a block diagram of a vehicle control device according to an embodiment of the present disclosure.

Referring to FIG. 2A, a vehicle control device 200 may include at least one of a processor 201 or a memory 203, or any combination thereof. The processor 201 and/or the memory 203 may be electronically and/or operably coupled with each other by an electronic component such as a communication bus.

According to an embodiment, hereinafter, combining pieces of hardware operatively may mean a direct connection or an indirect connection between the pieces of hardware being established in a wired or wireless manner such that first hardware of the pieces of hardware is controlled by second hardware of the pieces of hardware. Although different blocks are shown, embodiments are not limited thereto, and part of the hardware in FIG. 2A (e.g., at least a part of the processor 201 and the memory 203) may be included in a single integrated circuit, such as a system on a chip (SoC). The type and/or number of hardware included in the vehicle control device 200 is not limited to that shown in FIG. 2A.

According to an embodiment, the processor 201 of the vehicle control device 200 may include hardware for processing data based on one or more instructions. The hardware for processing data may include, for example, an arithmetic and logic unit (ALU), a floating point unit (FPU), a field programmable gate array (FPGA), a central processing unit (CPU), and/or an application processor (AP). The processor 201 of the vehicle control device 200 may have the structure of a single-core processor or the structure of a multi-core processor such as a dual core, quad core, or hexa core processor.

According to an embodiment, the processor 201 of the vehicle control device 200 may obtain at least one of sunlight amount information, temperature information, location information, or time information, or any combination thereof. According to an embodiment, the processor 201 of the vehicle control device 200 may store at least one of the obtained sunlight amount information, temperature information, location information, or time information, or any combination thereof in the memory 203.

According to an embodiment, the processor 201 of the vehicle control device 200 may transmit at least one of sunlight amount information, temperature information, location information, or time information, or any combination thereof to a server. The user may obtain a mileage as reward for the vehicle control device transmitting at least one of sunlight amount information, temperature information, location information, or time information, or any combination thereof to the server.

The mileage may be used to pay for good, information, or service identified based on the input of the user of the vehicle control device. The user of the vehicle control device may purchase energy facilities capable of obtaining sunlight amount information, temperature information, location information, and/or time information to obtain mileage. Therefore, the effect of increasing the penetration rate of energy facilities may be expected through embodiments of the present disclosure.

Although it is described in FIG. 2A that good, information, or service for which payment is made is identified based on the input of the user of the vehicle control device, embodiments of the present disclosure may not be limited thereto. According to an embodiment, good, information, or service for which payment is made may be identified based on the input of the user of the vehicle.

FIG. 2B is a diagram specifically showing a vehicle control device according to an embodiment of the present disclosure.

Referring to FIG. 2B, a vehicle control device 220 may include at least one of a processor 221, a memory 223, a roof panel 225, a temperature measurement device 227, or a communication circuit 229, or any combination thereof. The processor 221, the memory 223, the roof panel 225, the temperature measurement device 227 and/or the communication circuit 229 may be electronically and/or operably coupled with each other by an electronic component such as a communication bus.

Although different blocks are shown, embodiments are not limited thereto, and part of the hardware in FIG. 2B (e.g., at least a part of the processor 221, the memory 223, and the communication circuit 229) may be included in a single integrated circuit, such as a system on a chip (SoC). The type and/or number of hardware included in the vehicle control device 220 is not limited to that shown in FIG. 2B. For example, the vehicle control device 220 may include only some of hardware components shown in FIG. 2B.

According to an embodiment, the description of the processor 221 and/or the memory 223 may include the description of the processor 201 and/or the memory 203 of FIG. 2A, and thus, duplicate descriptions are omitted below.

According to an embodiment, the processor 221 of the vehicle control device 220 may obtain sunlight amount information through the roof panel 225. The sunlight amount information may represent the amount of sunlight falling on the vehicle, the vehicle's roof panel, the vehicle's solar cells, and/or the ground surface. The sunlight amount information may be identified based on the amount of solar energy generated per unit area. The roof panel 225 may include solar cells. The light-receiving surface of the solar cell that generates electricity by sunlight may be arranged to face the outside of the vehicle. This is because the roof panel receives more sunlight than other parts of the vehicle. According to an embodiment, the vehicle control device 220 may generate electricity and obtain sunlight amount information based on sunlight shining on a solar cell, but embodiments of the present disclosure may not be limited thereto.

According to an embodiment, the processor 221 of the vehicle control device 220 may obtain temperature information through the temperature measurement device 227. The temperature measurement device 227 may be provided in a vehicle including the vehicle control device 220. The temperature information may include the temperature of the atmosphere outside the vehicle.

According to an embodiment, the processor 221 of the vehicle control device 220 may obtain location information of the vehicle including the vehicle control device 220. For example, the location information may include latitude information and longitude information of the vehicle including the vehicle control device 220. For example, the location information may include address information of the vehicle including the vehicle control device 220. According to an embodiment, the processor 221 of the vehicle control device 220 may obtain location information through a GPS sensor, but embodiments of the present disclosure may not be limited thereto.

FIG. 2C is a block diagram of an information collection system according to an embodiment of the present disclosure.

Referring to FIC. 2C, an information collection system may include a vehicle control device 230 and a server 240. The vehicle control device 230 and the server 240 may transmit and/or receive weather-related information through wireless communication.

According to an embodiment, the vehicle control device 230 may obtain at least one of sunlight amount information, temperature information, location information, or time information, or any combination thereof. The vehicle control device 230 may transmit at least one of sunlight amount information, temperature information, or location information, or time information, or any combination thereof to the server 240.

According to an embodiment, the server 240 may provide a mileage to a user of the vehicle control device 230 as reward for receiving at least one of sunlight amount information, temperature information, location information, or time information, or any combination thereof.

According to an embodiment, the user of the vehicle control device 230 may purchase good, information, service, and/or benefit through the mileage. For example, the user of the vehicle control device 230 may purchase automobile items (e.g., wipers, steering wheels, wheels) through mileage. For example, the user of the vehicle control device 230 may purchase, through mileage, at least one of sunlight amount information, temperature information, location information, or time information, or any combination thereof for an area other than the area where the vehicle including the vehicle control device is located. For example, the user of the vehicle control device 230 may receive discount for a charging fee through the mileage.

According to an embodiment, the server 240 may pay and/or deduct mileage obtained by the user of the vehicle control device 230 based on the transaction history of good, information, service, and/or benefit.

FIG. 2D is a diagram specifically illustrating an information collection system according to an embodiment of the present disclosure.

Referring to FIG. 2D, a vehicle control device 250 may include at least one of a processor 251, a memory 253, or a communication circuit 255, or any combination thereof. The processor 251, the memory 253, and/or the communication circuit 255 may be electronically and/or operably coupled with each other by an electronic component such as a communication bus.

A server 260 may include at least one of a processor 261, a memory 263, or a communication circuit 265, or any combination thereof. The processor 261, the memory 263, and/or the communication circuit 265 may be electronically and/or operably coupled with each other by an electronic component such as a communication bus.

An external server 270 may include at least one of a processor 271, a memory 273, or a communication circuit 275, or any combination thereof. The processor 271, the memory 273, and/or the communication circuit 275 may be electronically and/or operably coupled with each other by an electronic component such as a communication bus.

According to an embodiment, the type and/or number of hardware included in the vehicle control device 250, the server 260, and/or the external server 270 is not limited to that shown in FIG. 2D. For example, the vehicle control device 250, the server 260, and/or the external server 270 may include only some of the hardware components shown in FIG. 2D.

According to an embodiment, the description of the vehicle control device 250 may include the description of the vehicle control device 200 of FIG. 2A, the description of the vehicle control device 220 of FIG. 2B, and/or the description of the vehicle control device 230 of FIG. 2C, and thus duplicate descriptions will be omitted below. Because the description of the server 260 may include the description of the server 240 of FIG. 2C, duplicate description will be omitted below.

According to an embodiment, the processor 261 of the server 260 may store a mileage for the user of the vehicle control device 250 and/or a mileage for the external server 270 in the memory 263.

According to an embodiment, the processor 261 of the server 260 may add and/or subtract the mileage obtained by the user of the vehicle control device 250 and/or the mileage of the external server 270.

For example, the processor 261 of the server 260 may award mileage to a user of the vehicle control device 250 as reward for at least one of received sunlight amount information, received temperature information, received location information, or received time information, or any combination thereof.

For example, the processor 261 of the server 260 may deduct mileage corresponding to the price of a good identified based on the input of the user of the vehicle control device for purchasing the good from mileage obtained by the user of the vehicle control device 250. In other words, the user of the vehicle control device 250 may use mileage as reward for a purchased good.

For example, the processor 261 of the server 260 may transmit at least one of received sunlight amount information, received temperature information, received location information, or received time information, or any combination thereof to the external server 270, for sale. A user of the external server 270 may purchase at least one of sunlight amount information, temperature information, location information, or time information, or any combination thereof through mileage.

According to an embodiment, the external server 270 may be controlled by a business operator (e.g., smart farm operator or Korea Meteorological Administration) that processes and utilizes weather-related information. The external server 270 may transmit, to the server 260, the input of the user of the external server 270 for specifying at least one of sunlight amount information, temperature information, location information, or time information, or any combination thereof (e.g., specifying information in a specific time zone, specifying information in a specific area).

The server 260 may identify the input of the user of the external server 270 and transmit at least one of sunlight amount information, temperature information, location information, or time information, or any combination thereof based on receiving reward for at least one of specified sunlight amount information, specified temperature information, specified location information, or specified time information, or any combination thereof.

According to one embodiment, the reward for at least one of specified sunlight amount information, specified temperature information, specified location information, or specified time information, or any combination thereof may include a payment other than mileage and may be paid in a variety of ways, such as card payment or account transfer.

According to an embodiment, the server 260 may perform a payment for purchasing at least one of specified sunlight amount information, specified temperature information, specified location information, or specified time information, or any combination thereof, through mileage of the external server 270.

According to an embodiment, to perform payment, the server 260 may deduct the mileage corresponding to the price of at least one of specified sunlight amount information, specified temperature information, specified location information, or specified time information, or any combination thereof, from the mileage of the external server 270 before payment.

Although the above description has been given with reference to FIGS. 2A to 2D under assumption that the server sells weather-related information (e.g., sunlight amount information, temperature information, location information, time information) obtained from the vehicle control device to an external server, and the external server generates processed information (e.g., ultraviolet ray information, cloud amount information, maximum temperature information, minimum temperature information, and sunshine hours information) by processing the weather-related information, embodiments of the present disclosure may not be limited thereto. According to an embodiment, the server may generate processed information by processing weather-related information and then sell the processed information to the external server.

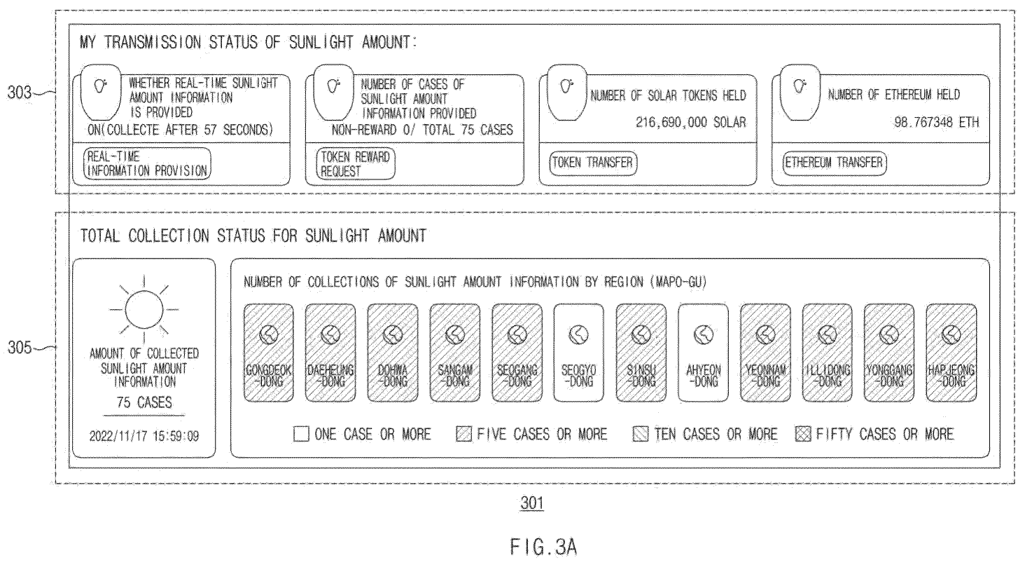

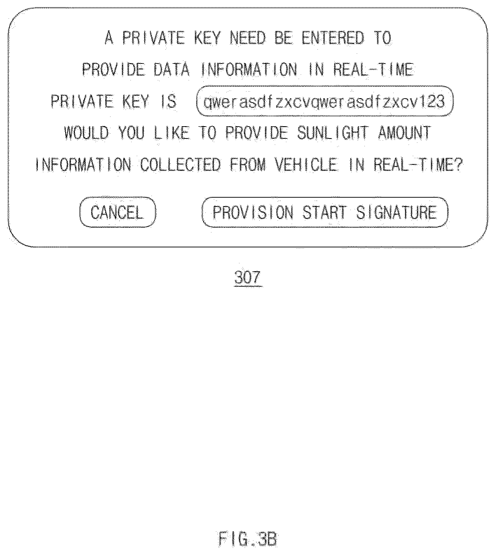

FIG. 3A shows an example of a screen displayed for information collection in an information collection system or information collection method according to an embodiment of the present disclosure.

FIG. 3B shows an example of a screen displayed for obtain an input of a user of a vehicle control device for providing weather-related information to a server in an information collection system or information collection method according to an embodiment of the present disclosure.

Referring to FIG. 3A and FIG. 3B, a screen 301 may include a first portion 303 for sale of weather-related information and a second portion 305 for purchase of weather-related information. A screen 307 may be displayed to obtain an input of a user of a vehicle control device for providing weather-related information to a server. Hereinafter, the weather-related information may include at least one of sunlight amount information, temperature information, location information, or time information, or any combination thereof. The screen 301 and the screen 307 may be provided to the user of the vehicle control device and/or the user of a vehicle through the vehicle control device or a terminal of the user of the vehicle control device.

According to an embodiment, the first portion 303 may include a user interface (UI) and/or user experience (UX) for guiding the user of the vehicle control device to sell obtained weather-related information to the server. Through the first portion 303, the user of the vehicle control device may identify the status of weather-related information held by the vehicle control device, the status of mileage held by the user of the vehicle control device, and the status of weather-related information for which no mileage is assigned. The user of the vehicle control device may generate an input for providing weather-related information to the server through the first portion 303. The vehicle control device may transmit weather-related information to the server based on the input of the user of the vehicle control device.

According to an embodiment, the second portion 305 may include a UI and/or UX for guiding a user of an external server to purchase weather-related information from the server. The user of the external server may identify the status of weather-related information available for purchase through the second portion 305. The weather-related information may be collected by multiple vehicle control devices operating in different regions. The user of the external server may generate an input for purchasing weather-related information from the server through the second portion 305. The user of the external server may generate an input for selecting a region of weather-related information which the user wishes to purchase, through the second portion 305. Although not shown in FIG. 3A and FIG. 3B, the user of the external server may generate an input for selecting the type of weather-related information (e.g., sunlight amount information, or temperature information) which the user wishes to purchase through the second portion 305.

According to an embodiment, the user of the vehicle control device may generate an input for providing weather-related information to the server through the screen 307. The vehicle control device may transmit the weather-related information to the server based on the input for providing weather-related information to the server. Transmitting weather-related information may require verification of security information (e.g., security key, vehicle ID). This is because personal information protection is necessary. The security information may include numbers, letters, and/or special characters. According to an embodiment, according to the selection of the user of the vehicle control device, the vehicle control device may provide weather-related information to the server at specified time intervals. According to an embodiment, according to the selection of the user of the vehicle control device, the vehicle control device may provide, to the server, only weather-related information corresponding to the input of the user of the vehicle control device.

Although it is described in FIG. 3A and FIG. 3B that weather-related information is provided to the server based on the input of the user of the vehicle control device, embodiments of the present disclosure may not be limited thereto. For example, weather-related information may be provided to the server in such a way that weather-related information is sold based on the input of the user of the vehicle.

Although the above description has been given with reference to FIG. 3A and FIG. 3B under assumption that the server sells weather-related information (e.g., sunlight amount information, temperature information, location information, time information) obtained from the vehicle control device to an external server, and the external server generates processed information (e.g., ultraviolet ray information, cloud amount information, maximum temperature information, minimum temperature information, and sunshine hours information) by processing the weather-related information, embodiments of the present disclosure may not be limited thereto. According to an embodiment, the server may generate processed information by processing weather-related information and then sell the processed information to the external server.

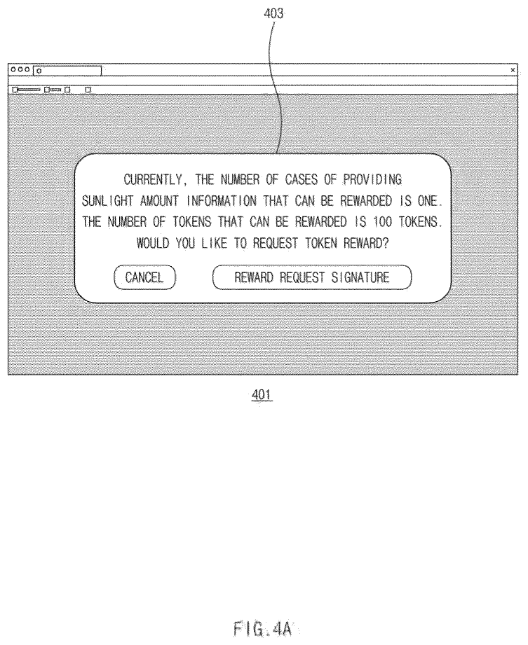

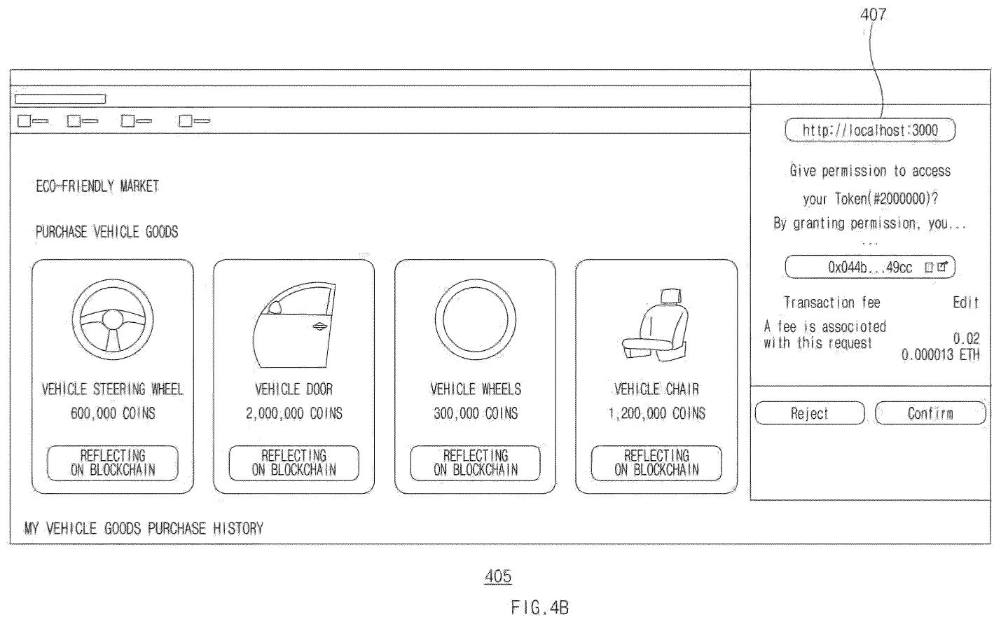

FIG. 4A shows an example of a screen displayed to obtain an input of a user in an information collection system or information collection method according to an embodiment of the present disclosure.

FIG. 4B shows an example of a screen displayed to obtain an input of a user of the vehicle control device specifying a good to purchase in an information collection system or information collection method according to an embodiment of the present disclosure.

Referring to FIG. 4A and FIG. 4B, a screen 401 may include an UI and/or UX for guiding the user of the vehicle control device to request assignment of mileage corresponding to the weather-related information for which no mileage is assigned after the weather-related information has been received. A screen window 403 may include a notification to guide the input of the user of the vehicle control device. A screen 405 may be displayed to obtain an input of a user of the vehicle control device specifying a good to purchase. Hereinafter, the weather-related information may include at least one of sunlight amount information, temperature information, location information, or time information, or any combination thereof. The screen 401 and the screen 405 may be provided to the user of the vehicle control device and/or the user of a vehicle through the vehicle control device or a terminal of the user of the vehicle control device.

According to an embodiment, in the screen 401, the screen window 403 may include an UI and/or UX for guiding an input of the user of the vehicle control device. The user of the vehicle control device may exchange weather-related information obtained by the vehicle control device with mileage through an input. Through the screen window 403, the user of the vehicle control device may generate an input for transmitting weather-related information to the server. Based on the input, the server may transmit weather-related information.

According to an embodiment, in the screen 405, the user of the vehicle control device may purchase a good using mileage. The user of the vehicle control device may obtain mileage in such a way that the vehicle control device transmits weather-related information to the server. The user of the vehicle control device may generate an input to specify a good to be purchased with mileage, on the screen 405. The user of the vehicle control device may generate an input to pay for a specified good on the screen 405. The mileage obtained by the user of the vehicle control device may be determined in such a way that the mileage corresponding to the price of the good specified on the screen 405 is deducted from mileage before payment is made. According to an embodiment, when the mileage obtained by the user of the vehicle control device is lower than the price of the good specified on the screen 405, a difference between the price of the specified good and a mileage obtained by the user of the vehicle control device may be paid using another method (e.g. bank transfer, card payment). It should be noted that the embodiments of the present disclosure may not be limited thereto.

In FIG. 4A and FIG. 4B, the server for purchasing goods and the server that receives weather-related information from the vehicle control device are shown as if they are operated by the same entity, but the embodiment of the present disclosure may not be limited thereto.

Although it is described in FIG. 4A and FIG. 4B that the user of the vehicle control device requests assignment of mileage corresponding to weather-related information for which no mileage has been assigned, embodiments of the present disclosure may not be limited thereto. According to an embodiment, the user of the vehicle may request assignment of mileage corresponding to weather-related information for which no mileage has been assigned.

Although it is described in FIG. 4A and FIG. 4B that the user of the vehicle control device generates an input for transmitting weather-related information to the server, embodiments of the present disclosure may not be limited thereto. According to an embodiment, the user of a vehicle may generate an input for transmitting weather-related information to a server.

Although it is described in in FIG. 4A and FIG. 4B that the user of the vehicle control device purchases a good using mileage, embodiments of the present disclosure may not be limited thereto. According to an embodiment, the user of the vehicle may purchase a good using mileage.

Although the above description has been given with reference to FIG. 4A and FIG. 4B under assumption that the server sells weather-related information (e.g., sunlight amount information, temperature information, location information, time information) obtained from the vehicle control device to an external server, and the external server generates processed information (e.g., ultraviolet ray information, cloud amount information, maximum temperature information, minimum temperature information, and sunshine hours information) by processing the weather-related information, embodiments of the present disclosure may not be limited thereto. According to an embodiment, the server may generate processed information by processing weather-related information and then sell the processed information to the external server.

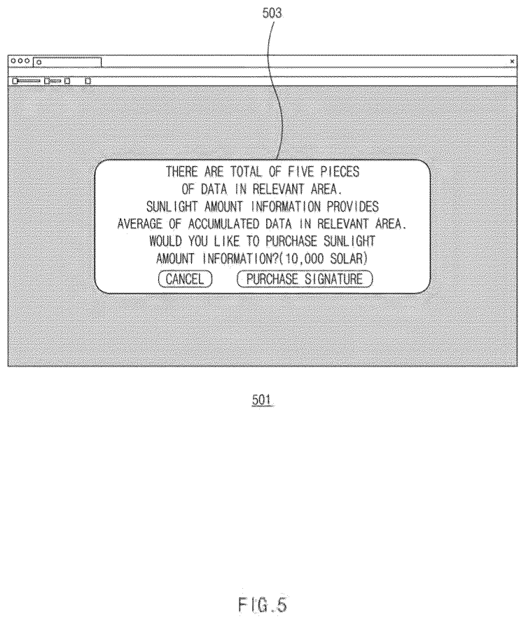

FIG. 5 shows an example of a screen displayed for information sale in an information collection system or information collection method according to an embodiment of the present disclosure.

Referring to FIG. 5, a screen 501 may be displayed to obtain an input of a user of an external server for providing weather-related information to the external server. A screen window 503 may include UI and/or UX to guide the input of the user of the external server. Hereinafter, the weather-related information may include at least one of sunlight amount information, temperature information, location information, or time information, or any combination thereof.

According to an embodiment, users of an external server may be collected by a plurality of vehicle control devices operating in different regions. A user of an external server may generate an input for purchasing weather-related information from the server. A user of an external server may generate an input for selecting weather-related information for a region which the user wishes to purchase. In the screen window 503, a user of the external server may generate an input for paying for weather-related information.

According to an embodiment, the server may sell weather-related information purchased through mileage from a vehicle control device to a user of the external server, based on the payment of the user of the external server.

According to an embodiment, according to the configuration of a system, the sale of weather-related information may occur regardless of the intention of a user of the vehicle control device. The server may purchase weather-related information from the user of the vehicle control device through mileage and sell the weather-related information to a user of an external server for a fee.

According to another embodiment, the sale of weather-related information may occur after it is identified that the sales intention of the user of the vehicle control device matches the purchase intention of the user of the external server. The server may act as an introducer between the user of the vehicle control device and the user of the external server, and may play a role in delivering reward corresponding to weather-related information from the user of the external server to the user of the vehicle control device.

As mentioned above, according to an embodiment, the user of the external server may process and utilize weather-related information. For example, the external server may be controlled by a smart farm operator. The smart farm operator may adjust the growing environment (e.g. temperature or humidity) of crops based on obtained weather-related information. For example, the external server may be controlled by a weather information consumer such as the Korea Meteorological Administration. The weather information consumer may sell, to general consumers, processed information (e.g., ultraviolet ray information, cloud amount information, maximum temperature information, minimum temperature information, and sunshine hours information) that is the result of processing the obtained weather-related information. According to an embodiment, the user of the external server may obtain mileage by paying a fee, but embodiments of the present disclosure may not be limited thereto.

Although the above description has been given with reference to FIG. 5 under assumption that the server sells weather-related information (e.g., sunlight amount information, temperature information, location information, time information) obtained from the vehicle control device to an external server, and the external server generates processed information (e.g., ultraviolet ray information, cloud amount information, maximum temperature information, minimum temperature information, and sunshine hours information) by processing the weather-related information, embodiments of the present disclosure may not be limited thereto. According to an embodiment, the server may generate processed information by processing weather-related information and then sell the processed information to the external server.

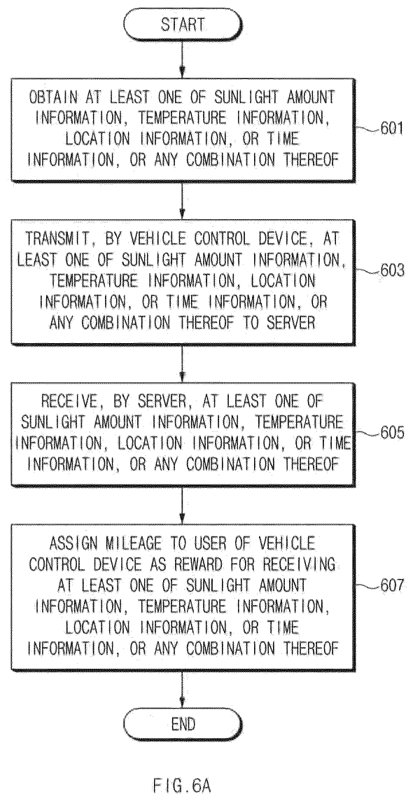

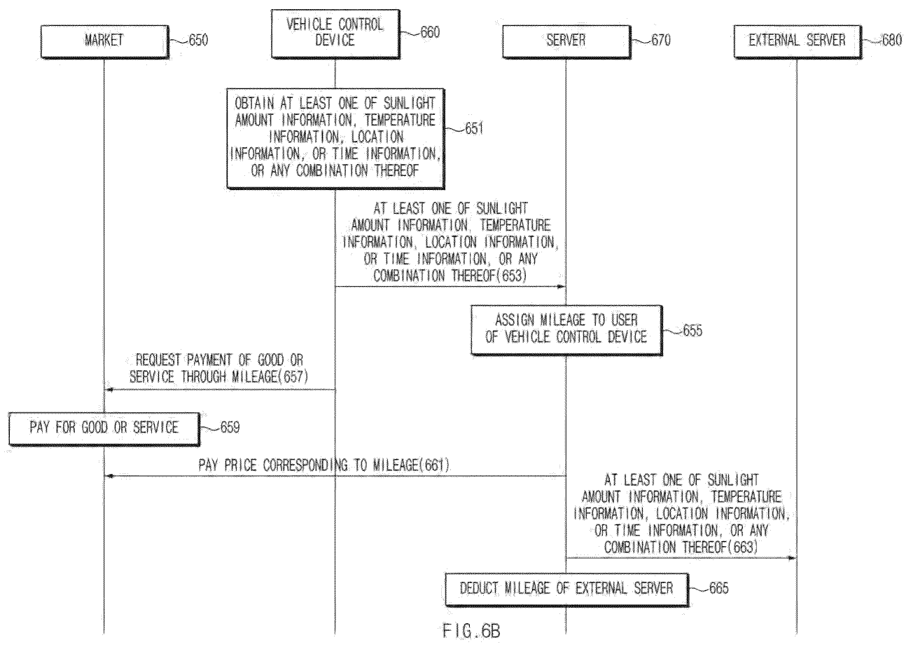

FIG. 6A shows a flowchart of operations of a vehicle control device and a server for information collection in an information collection system or information collection method according to an embodiment of the present disclosure.

Referring to FIG. 6A, in operation 601, a vehicle control device may obtain at least one of sunlight amount information, temperature information, location information, or time information, or any combination thereof. According to an embodiment, the vehicle control device may obtain the sunlight amount information through a roof panel. The vehicle control device may obtain the temperature information through a temperature measuring device provided in a vehicle.

In operation 603, the vehicle control device may transmit at least one of the sunlight amount information, the temperature information, the location information, or the time information, or any combination thereof to a server. The vehicle control device may transmit at least one of obtained sunlight amount information, obtained temperature information, obtained location information, or obtained time information, or any combination thereof to the server based on the input of a user of the vehicle control device for user to obtain mileage.

In operation 605, the server may receive at least one of sunlight amount information, temperature information, location information, or time information, or any combination thereof. The server may store at least one of received sunlight amount information, received temperature information, received location information, or received time information, or any combination thereof.

In operation 607, the server may assign mileage to the user of the vehicle control device as reward for receiving at least one of sunlight amount information, temperature information, location information, or time information, or any combination thereof. The mileage may be used to perform payment for good, information, or service, that is managed by the server and identified based on an input of the user of the vehicle control device. The user of the vehicle control device may purchase energy facilities capable of obtaining sunlight amount information, temperature information, location information, and/or time information to obtain mileage. According to the embodiments of the present disclosure, it may be expected to increase the penetration rate of energy facilities.

Although it is described in FIG. 6A that good, information, or service for which payment is made is identified based on the input of the user of the vehicle control device, embodiments of the present disclosure may not be limited thereto. According to an embodiment, good, information, or service to be paid for may be identified based on an input of the user of the vehicle.

Although it is described in FIG. 6A that at least one of the obtained sunlight amount information, the obtained temperature information, the obtained location information, or the obtained time information, or any combination thereof is transmitted to the server based on an input of the user of the vehicle control device, embodiments of the present disclosure may not be limited thereto. According to an embodiment, at least one of obtained sunlight amount information, obtained temperature information, obtained location information, or obtained time information, or any combination thereof may be transmitted to the server based on the input of the user of the vehicle.

FIG. 6B shows an example of signaling between a vehicle control device, a server, an external server, and a market for information collection in an information collection system or information collection method according to an embodiment of the present disclosure.

Referring to FIG. 6B, in operation 651, a vehicle control device 660 may obtain at least one of sunlight amount information, temperature information, location information, or time information, or any combination thereof. Because operation 651 is performed in the same manner as operation 601 of FIG. 6A, an overlapping description will be omitted below.

In operation 653, the vehicle control device 660 may transmit at least one of sunlight amount information, temperature information, location information, or time information, or any combination thereof to a server 670. The server 670 may receive at least one of the sunlight amount information, the temperature information, the location information, or the time information, or any combination thereof from the vehicle control device 660. Because operation 653 is performed in the same manner as operation 603 and operation 605 of FIG. 6A, an overlapping description will be omitted below.

In operation 655, the server 670 may assign mileage to a user of the vehicle control device 660. The server 670 may assign mileage to the user of the vehicle control device 660 based on receiving at least one of sunlight amount information, temperature information, location information, or time information, or any combination thereof. Because operation 655 is performed in the same manner as operation 607 of FIG. 6A, an overlapping description will be omitted below.

The user of the vehicle control device 660 may purchase a good using the mileage of the vehicle control device 660. In other words, the server 670 may perform payment for the good based on the input of the user of the vehicle control device 660 for purchasing the good and the mileage obtained by the user of the vehicle control device 660. The server 670 may deduct the mileage corresponding to the price of the good from the mileage obtained by the user of the vehicle control device 660.

In operation 657, the vehicle control device 660 may request payment for good or service from a market 650 through mileage. The market 650 may receive a request for payment for good or service through mileage from the vehicle control device 660. The market 650 may sell good or service to the user of the vehicle control device 660 through mileage.

In operation 659, the market 650 may perform payment for good or service. The market 650 may receive mileage obtained by the user of the vehicle control device 660 to make payment for good or service.

In operation 661, the server 670 may pay a price corresponding to the mileage to the market 650. According to an embodiment, the server 670 may pay the market 650 a price corresponding to the mileage owned by the user of the vehicle control device 660, which is obtained by the market 650. However, embodiments of the present disclosure may not be limited thereto. According to one embodiment, the mileage obtained by the market 650 may be used like currency between affiliated stores.

In operation 663, the server 670 may transmit at least one of sunlight amount information, temperature information, location information, or time information, or any combination thereof to an external server 680. The external server 680 may receive at least one of sunlight amount information, temperature information, location information, or time information, or any combination thereof from the server 670. The user of the external server 680 may specify at least one of sunlight amount information, temperature information, location information, or time information, or any combination thereof, which the user wishes to purchase through an input.

In operation 665, the server 670 may deduct the mileage of the external server 680. The server 670 may deduct the mileage of the external server 680 based on transmitting at least one of sunlight amount information, temperature information, location information, or time information, or any combination thereof to the external server 680. The mileage of the external server 680 may be assigned from the server 670 by paying a fee to the server 670, but embodiments of the present disclosure may not be limited thereto.

Although it is described in FIG. 6B that the user of the vehicle control device 660 is able to purchase a good through mileage obtained by the user of the vehicle control device 660, embodiments of the present disclosure may not be limited thereto. According to an embodiment, the user of the vehicle may purchase a good through mileage.

In operation 663 of FIG. 6B, the server 670 is described as transmitting at least one of the obtained sunlight amount information, temperature information, location information, or time information, or any combination thereof to the external server 680, but embodiments of the disclosure may not be limited thereto. According to an embodiment, the server 670 may identify processed information (e.g., ultraviolet ray information, cloud amount information, maximum temperature information, minimum temperature information, sunlight time information) based on weather-related information (e.g., sunlight amount information, temperature information, location information, or time information) received from the vehicle control device 660. For example, the server 670 may identify that the larger the sunlight amount information, the smaller the cloud amount information. For example, the server 670 may identify maximum temperature information indicating the highest temperature during a specified time through time information and temperature information. For example, the server 670 may identify minimum temperature information indicating the lowest temperature during a specified time through time information and temperature information. The server 670 may transmit the processed information to the external server 680 in response to receiving reward for the processed information from the external server 680.

Examples of codes for implementing embodiments of the present disclosure are described below. However, embodiments of the present disclosure may not be limited thereto.

In Table 1 below, examples of an information structure of the user of the vehicle control device, a weather-related information structure, a weather-related information purchase structure, and a market structure for purchasing goods are described. The information structure of the user of the vehicle control device may be defined as userInfo, the weather-related information structure may be defined as solarInfo, the weather-related information purchase structure may be defined as buySolarInfo, and the market structure for purchasing goods may be defined as buyCarItem.

TABLE 1

```
import “./token/ERC20/IERC20.sol”;
import “./token/ERC20/extensions/IERC20Metadata.sol”;
import “./utils/context.sol”;
import “./access/Ownable.sol”;
contract solarManagement is Context, Ownable{
  uint256 public totalUserCount;
  uint256 public totalSolarCount;
  uint256 public total BuySolarCount;
  uint256 public totalCarCount;
  struct userInfo{
    address user;
    bool provide;
    uint256 submitted;
    uint256 compensated;
  }
  struct solarInfo{
    uint256 timestamp;
    address user;
    uint256 area;
    string sunshine;
    address receiver;
  }
  struct buySolarInfo{
    address user;
    uint256 timestamp;
    uint256 area;
    string sunshine;
    address sender;
  }
  struct buyCarItem{
    address user;
    uint256 timestamp;
    string name;
    uint256 price;
    address sender;
  }
  userInfo[ ] public userList;
  solarInfo[ ] public solarList;
  buySolarInfo[ ] public buySolarList;
  buyCarItem[ ] public buyCarList;
  IERC20 private_currencyAddr;
```

In Table 2 below, an example of codes for providing weather-related information included in the information structure of the user of the vehicle control device is described. The vehicle control device may call location information and weather-related information, and transmit the weather-related information to the server. The value of a variable (e.g., submitted) indicating the number of times weather-related information has been submitted when transmitting the weather-related information may increase. Additionally, the value of the obtained weather-related information may be stored.

TABLE 2

```
function provideInfo(uint256 area_,string memory
sunshine_) public returns (string memory) {
  for(uint256 i=0; i<totalUserCount; i++) {
    if(userList[i].user == msg.sender){
      solarList.push(solarInfo(block.timestamp,
      msg.sender, area_, sunshine_, address(this)));
      userList[i].submitted=userList[i].submitted+1;
      totalSolarCount=totalSolarCount+1;
      emit ProvideInfo(area_, sunshine_);
      return “success”;
    }
  }
  revert(“Failed to Provide Information.”);
}
```

In Table 3, an example of codes included in the information structure of the user of the vehicle control device and used to allow the user of the vehicle control device to receive mileage is described. The codes below may be called when requesting mileage as reward for transmitted weather-related information.

TABLE 3

```
function compensate( ) public returns(string memory){
  for(uint256 i=0; i<totalUserCount; i++) {
    if(userList[i].user == msg.sender){
      if(userList[i].submitted>msg.sender){
        _currencyAddr.transfer(msg.sender,
        (userList[i].submitted-
        userList[i].compensated)*100);
        userList[i].compensated= userList[i].submitted;
        emit ProvideInfo(area_, sunshine_);
        return “Success”;
      }
    }
  }
  revert(“User is Not Registered or There's not Enough Info for
  Compensation.”);
}
```

In Table 4 below, an example of codes for purchasing goods included in the market structure is described. Through the codes below, based on a good to be purchased and a price, mileage corresponding to the price may be transmitted to the server, and then the good purchase history (buycarItem) may be updated.

TABLE 4

```
function purchaseItem(string memory item_,
uint256 price_) public returns(string memory){
  _currencyAddr.transferFrom(msg.sender,
  address(this), price_);
  buyCarList.push(buyCarItem(msg.sender,
  block.timestamp, item_, price_, address(this)));
  totalCarCount=totalCarCount+1;
  return “Success”;
}
```

In Table 5 below, an example of codes for selling weather-related information to an external server, included in the weather-related information purchase structure, is described. After the specified weather-related information and mileage corresponding to the price of the specified weather-related information are transmitted to the server through the codes below, the information purchase history (buySolarInfo) may be updated.

TABLE 5

```
function purchaseInfo(uint256 area_, string memory
sunshine_, uint256 price_) public returns(string
memory){
  for(uint256 i=0; i<totalUserCount; i++) {
    if(solarList[i].area=area_){
      _currencyAddr.transferform(msg.sender,
      address(this), price_);
      buySolarList.push(buySolarInfo(msg.sender,
      block.timestamp, area_, sunshine_,
      address(this)));
      totalBuySolarCount=totalBuySolarCount+1;
      emit Purchase(area_, sunshine_, price);
      return “Success”;
    }
  }
  revert(“Failed to Buy Info”)
}
```

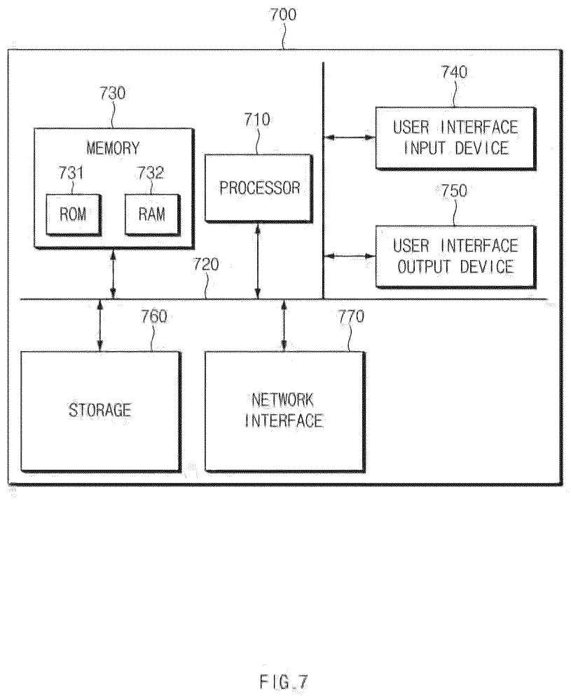

FIG. 7 shows a computing system related to an information collection system or information collection method according to an embodiment of the present disclosure. Referring to FIG. 7, a computing system 700 may include at least one processor 710, a memory 730, a user interface input device 740, a user interface output device 750, storage 760, and a network interface 770, which are connected with each other via a bus 720.

The processor 710 may be a central processing unit (CPU) or a semiconductor device that processes instructions stored in the memory 730 and/or the storage 760. The memory 730 and the storage 760 may include various types of volatile or non-volatile storage media. For example, the memory 730 may include a ROM (Read Only Memory) 731 and a RAM (Random Access Memory) 732.

Thus, the operations of the method or the algorithm described in connection with the embodiments disclosed herein may be embodied directly in hardware or a software module executed by the processor 710, or in a combination thereof. The software module may reside on a storage medium (that is, the memory 730 and/or the storage 760) such as a RAM, a flash memory, a ROM, an EPROM, an EEPROM, a register, a hard disk, a removable disk, and a CD-ROM.

The exemplary storage medium may be coupled to the processor 710, and the processor 710 may read information out of the storage medium and may record information in the storage medium. Alternatively, the storage medium may be integrated with the processor 710. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the embodiment disclosed in the present disclosure is not intended to limit the technical idea of the present disclosure but to describe the present disclosure, and the scope of the technical idea of the present disclosure is not limited by the embodiment. The scope of protection of the present disclosure should be interpreted by the following claims, and all technical ideas within the scope equivalent thereto should be construed as being included in the scope of the present disclosure.

The present technology may increase the penetration rate of energy production facilities and enhance user experience by exchanging information produced through energy production facilities with mileage.

In addition, the present technology may increase the penetration rate of energy production facilities and enhance user experience by enabling payment for goods through mileage.

Further, the present technology may increase users' confidence in their mileage by trading mileage through a distributed network.

Further, the present technology may establish a sustainable mileage production and distribution structure by allowing external servers to purchase data produced through energy production facilities.

In addition, various effects may be provided that are directly or indirectly understood through the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control device comprising:
a memory configured to store program instructions; and
a processor configured to execute the program instructions, wherein the processor is configured to:
obtain at least one of sunlight amount information indicating an amount of sunlight shining on a vehicle including the vehicle control device, temperature information indicating an external temperature of the vehicle, location information indicating a location of the vehicle, or time information; and
provide a user of the vehicle control device with mileage in response to transmitting at least one of the obtained sunlight amount information, the obtained temperature information, the obtained location information, or the obtained time information to a server,
wherein the mileage is provided to the user as a reward for transmitting the obtained sunlight amount information, the obtained temperature information, the obtained location information, or the obtained time information, which is identified based on an input of the user of the vehicle control device,
wherein the time information indicates a time at which at least one of the obtained sunlight amount information, the obtained temperature information, or the obtained location information is obtained.

2. The vehicle control device of claim 1, further comprising:
a roof panel equipped with a solar cell that generates electricity by the sunlight and configured to generate the sunlight amount information,
wherein a light-receiving surface of the solar cell included in the roof panel is disposed toward outside of the vehicle.

3. The vehicle control device of claim 1, wherein the mileage is configured to be used as payment for a good, information, or a service.

4. The vehicle control device of claim 1, wherein the mileage is generated using blockchain technology and assigned to a user from the server,

5. The vehicle control device of claim 1, wherein the processor is configured to provide a user interface (UI) or a user experience (UX) for guiding the user to sell at least one of the obtained sunlight amount information, the obtained temperature information, the obtained location information, or the obtained time information to the server.

6. The vehicle control device of claim 1, wherein the processor is configured to provide a user interface (UI) or a user experience (UX) for guiding the user to request assignment of mileage corresponding to at least one of sunlight amount information for which the mileage is not assigned, temperature information for which the mileage is not assigned, location information for which the mileage is not assigned, or time information for which the mileage is not assigned after transmitting at least one of the obtained sunlight amount information, the obtained temperature information, the obtained location information, or the obtained time information to the server.

7. The vehicle control device of claim 1, wherein at least one of the sunlight amount information, the temperature information, the location information, or the time information is used to identify processed information that represents weather-related information.

8. A vehicle comprising the vehicle control device of claim 1.

9. An information collection system comprising:
a vehicle control device; and
a server,
wherein the vehicle control device is configured to:
obtain at least one of sunlight amount information indicating an amount of sunlight shining on a vehicle including the vehicle control device, temperature information indicating an external temperature of the vehicle, location information indicating a location of the vehicle, or time information; and
transmit at least one of the obtained sunlight amount information, the obtained temperature information, the obtained location information, or the obtained time information,
wherein the server is configured to:
receive at least one of the obtained sunlight amount information, the obtained temperature information, the obtained location information, or the obtained time information; and
assign mileage to the user of the vehicle control device in response to receiving at least one of the obtained sunlight amount information, the obtained temperature information, the obtained location information, or the obtained time information,
wherein the mileage is managed by the server, and is used as a reward for transmitting the obtained sunlight amount information, the obtained temperature information, the obtained location information, or the obtained time information, which is identified based on an input of the user of the vehicle control device, and
wherein the time information indicates a time at which at least one of the obtained sunlight amount information, the obtained temperature information, or the obtained location information is obtained.

10. The information collection system of claim 9, wherein the server is configured to apply the mileage as payment for a good, information, or a service.

11. The information collection system of claim 9, wherein the server is configured to update information included in mileage obtained by the user of the vehicle control device and information included in mileage obtained by a user of the vehicle control device different from the user of the vehicle control device with details of the assigned or deducted mileage.

12. The information collection system of claim 9, wherein the server is configured to:
identify an input of a user of an external server for specifying at least one of the sunlight amount information, the temperature information, the location information, or the time information; and
transmit at least one of the specified sunlight amount information, the specified temperature information, the specified location information, or the specified time information to the external server, in response to receiving at least one of the specified sunlight amount information, the specified temperature information, the specified location information, or the specified time information.

13. The information collection system of claim 12, wherein the server is configured to perform a payment for purchasing at least one of the specified sunlight amount information, the specified temperature information, the specified location information, or the specified time information from the server through mileage of the external server.

14. The information collection system of claim 13, wherein the server is configured to deduct the mileage of the external server before the payment is performed by a mileage corresponding to the price of at least one of the specified sunlight amount information, the specified temperature information, the specified location information, or the specified time information to perform the payment.

15. The information collection system of claim 9, wherein the server is configured to:
provide the vehicle control device or a terminal of the user with a user interface (UI) or a user experience (UX) for guiding the user to sell at least one of the obtained sunlight amount information, the obtained temperature information, the obtained location information, or the obtained time information to the server; and
provide the external server or a terminal of the user of the external server with a user interface (UI) or a user experience (UX) for guiding the user of the external server to purchase at least one of the sunlight amount information, the temperature information, the location information, or the time information from the server.

16. The information collection system of claim 9, wherein the server is configured to provide the vehicle control device or a terminal of a user with a user interface (UI) or a user experience (UX) for guiding the user to request assignment of mileage corresponding to at least one of sunlight amount information for which the mileage is not assigned, temperature information for which the mileage is not assigned, location information for which the mileage is not assigned, or time information for which the mileage is not assigned after receiving at least one of the obtained sunlight amount information, the obtained temperature information, the obtained location information, or the obtained time information from the vehicle control device.

17. The information collection system of claim 9, wherein the server is configured to:
identify processed information representing weather-related information based on at least one of the obtained sunlight amount information, the obtained temperature information, the obtained location information, or the obtained time information; and
transmit the processed information to the external server in response to receiving reward for the processed information from the external server.

18. An information collection method comprising:
obtaining, by a vehicle control device, at least one of sunlight amount information indicating an amount of sunlight shining on a vehicle including the vehicle control device, temperature information indicating an external temperature of the vehicle, location information indicating a location of the vehicle, or time information;
transmitting, by the vehicle control device, at least one of the obtained sunlight amount information, the obtained temperature information, the obtained location information, or the obtained time information to a server;
receiving, by the server, at least one of the obtained sunlight amount information, the obtained temperature information, the obtained location information, or the obtained time information from the vehicle control device; and
assigning, by the server, to a user of the vehicle control device, mileage as a reward for receiving at least one of the obtained sunlight amount information, the obtained temperature information, the obtained location information, or the obtained time information,
wherein the time information indicates a time at which at least one of the obtained sunlight amount information, the obtained temperature information, or the obtained location information is obtained.

19. The information collection method of claim 18, further comprising:
updating, by the server, information included in mileage obtained by the user of the vehicle control device and information included in mileage obtained by a user of the vehicle control device different from the user of the vehicle control device with details of the assigned or deducted mileage.

20. The information collection method of claim 18, identifying, by the server, an input of a user of an external server for specifying at least one of the sunlight amount information, the temperature information, the location information, or the time information; and
transmitting, by the server, at least one of the specified sunlight amount information, the specified temperature information, the specified location information, or the specified time information to the external server, in response to receiving reward for at least one of the specified sunlight amount information, the specified temperature information, the specified location information, or the specified time information.
